(19) United States
(12) Patent Application Publication
(10) Pub. No.: US 2019/0242138 A1
(43) Pub. Date: Aug. 8, 2019

(54) PANEL

(71) Applicant: Guido SCHULTE, Rüthen-Meiste (DE)

(72) Inventor: Guido SCHULTE, Rüthen-Meiste (DE)

(21) Appl. No.: 16/317,412

(22) PCT Filed: May 24, 2017
(86) PCT No.: PCT/DE2017/100449

§ 371 Date: Jan. 11, 2019

(30) Foreign Application Priority Data
Jul. 12, 2016 (DE) 10 2016 112 792.2

(51) Int. Cl. E04F 15/10; B32B 3/02; B32B 7/022; B32B 7/12; B32B 27/10; B32B 27/40; E04F 15/02

(52) U.S. Cl. CPC E04F 15/107; E04F 2290/043; B32B 7/022; B32B 7/12; B32B 27/10; B32B 27/40; E04F 15/105; E04F 15/02172; E04F 15/0215; B32B 2260/028; B32B 2260/046; B32B 2250/05; B32B 2255/10; B32B 2307/72; B32B 2307/51; B32B 2307/102; B32B 2307/558; B32B 2471/00; B32B 2307/744; B32B 2307/732; B32B 2307/584; B32B 2451/00; B32B 3/02

(57) ABSTRACT

A panel having side edges for connection to a further panel in order to cover a surface of a room, includes an upper side, an underside, and at least four side edges. The panel has a multilayer structure including an elastic base layer, made entirely or predominantly of an elastically adjusted polyurethane, and above the base layer a top layer which compared to the base layer is less elastic. The top layer is pressed via an adhesive layer with the base layer to form the multi-layer structure.

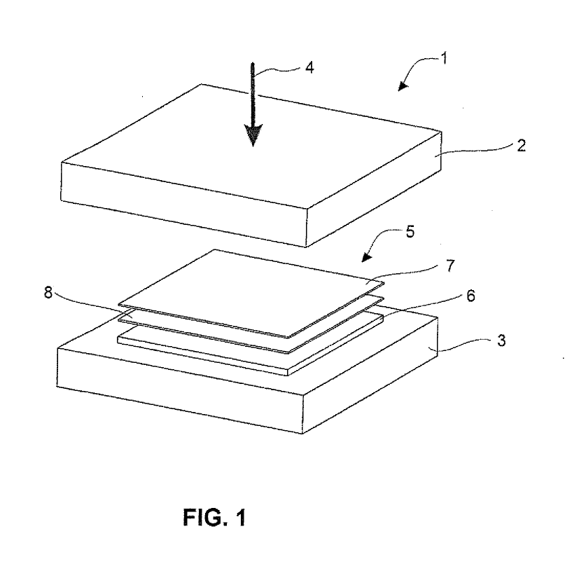

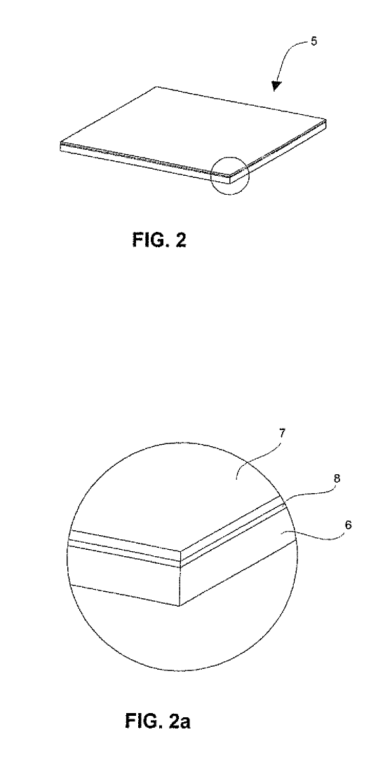

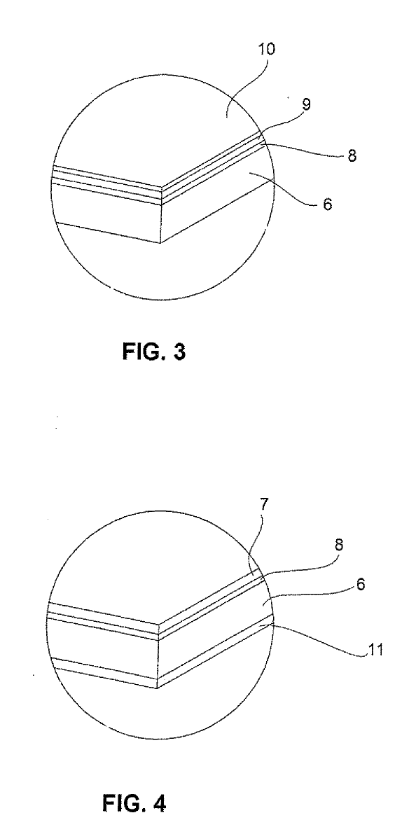

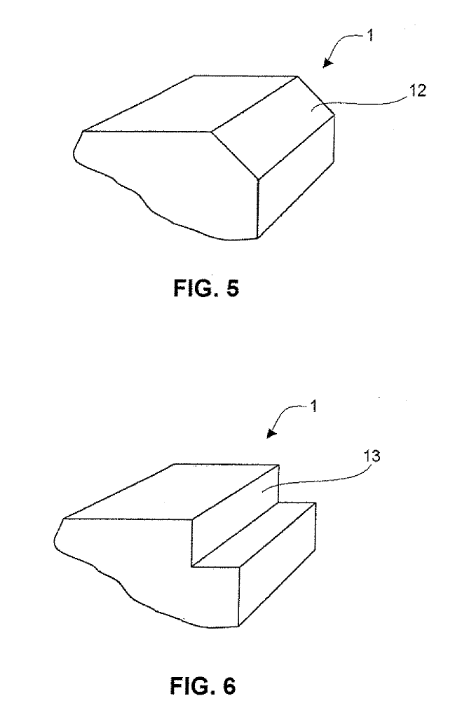

The invention relates to a panel with the features of patent claim 1.

From EP 30 20 885 A1, it is known to provide a panel for forming a waterproof floor, with the panel having a core of a thermoplastic material, a firm top layer and a reinforcing layer between the top layer and the core. The material of the core is preferably PVC, PE or ABS. The reinforcing layer preferably contains PVC and/or PE and is preferably hard. The reinforcing layer is preferably welded or glued to the core.

The invention is based on the object to provide an industrially producible panel that can be glued or fixed flatly upon a subfloor to cover an area of a room, in particular the floor.

Patent claim 1 sets forth such a panel.

A method for the production of such a panel is subject matter of patent claim 11.

The panel has an upper side, an underside, and at least four side edges. The side edges can have a bevel, a fold or a rabbet at least in part in the transition to the upper side. The chamfer or fold configurations may have various decorative shapes or colors, deviating from the actual surface colors or designs. The panel according to the invention has a multilayer structure. It includes a resilient base layer. The base layer is made entirely or predominantly of an elastically adjusted polyurethane. The polyurethane content of the base layer itself is in any case adjusted elastically. Less elastic additives may be embedded in the polyurethane, while the base layer remains elastic overall. Arranged above the base layer is a top layer which is less elastic in comparison with the base layer. The top layer is pressed via an adhesive layer with the base layer to the multilayer structure.

The polyurethane-based panel according to the invention should have substantially elastomeric properties. Such a panel is flexible and in particular unbreakably flexible, at a roller diameter greater than or equal to 50 mm, or a bending radius of at least 25 mm. Due to the elastomeric properties, such a panel has a good impression resistance. In addition, the adhesive layer should behave compliantly. The adhesive layer should be made of thermoplastically adjusted polyurethane, a polyamide or a polyester. The starting product of the adhesive layer is arranged between the top layer and the base layer as film or powder before the top layer is pressed with the base layer.

The top layer is multilayered. It has at least one decorative layer and at least one protective layer arranged above the decorative layer. The decorative layer is preferably produced on the basis of cellulose. The decorative layer may include several plies of cellulose-based layers. Preferably, the at least one cellulose-based layer involves a layer of paper, with an upper one of the at least two layers having a decorative surface. The at least one decorative layer is preferably impregnated with a curable synthetic resin. This involves preferably an aminoplastic resin, a melamine resin, a polyurethane, or a mixture of the aforementioned substances. The proportion by weight of the impregnation is 70 to 130 percent by weight. The decorative layer can have a structure that matches in sync with the decor image. The surface of the finished panel may have different gloss levels, preferably 3 to 4 different gloss levels, matching or suited to the decor image. Depending on the number of decorative layers, the top layer has a thickness in the range of 0.10 to 0.50 mm.

The protective layer above the decorative layer preferably contains antiabrasive constituents. The protective layer, which is also referred to as overlay, may involve a layer of impregnated noble cellulose, which becomes transparent during pressing. The protective layer can, as an alternative, also be applied as a liquid layer or as a powder onto the decorative layer and it combines with the decorative layer during pressing.

According to the invention, all components, i.e., viewed from top to bottom, the protective layer (overlay), the at least one decorative layer, the adhesive layer and the base layer are pressed together in a single operation. It is not the resin from the impregnated decorative layer that acts as adhesive between the top layer and the base layer, but supplementing or exclusively the adhesive layer. This means that an adhesive layer, e.g. as film, in powder form or as a pasty hot melt, is applied to supplement the decorative layer, which preferably involves an impregnated decorative paper. The adhesive layer is applied at an amount of at least 15 g/m², preferably at least 60 g/m².

This is a difference to conventional laminate structures, with HDF boards. The prefabricated parts of the panel according to the invention are therefore the base layer and the decorative layer, which can also be designated as decorative component of the top layer. The pressing time of the components amounts to 8 to 30 seconds. The temperature at the pressing surface of a decor-side press plate is between 150° C. and 220° C. According to the current state of the art, decorative papers or surface materials impregnated with aminoplastics can only be pressed “directly” with the board in your operating cycle only with wooden-based boards and thereby allow hardening and embossing of the surfaces. This is now also possible within the scope of the described novel invention with a water-resistant base layer of polyurethane, though with the aid of an adhesive, preferably a powder-based adhesive, that can be activated by heat and pressure. The adhesive is suited in terms of its film activation temperature and heat exposure time to the reaction conditions of the decorative top layer, including the protective layer.

The panel according to the invention retains its elastomeric properties even when its own weight is increased. Preferably, the base layer of the elastically adjusted polyurethane contains mineral-based additives or synthetic equivalents on the basis thereof, for example fine-grained mineral-based additives. In this way, the density of the base layer is adjusted greater than 1.5 g/cm³. Preferably, the density of the base layer is greater than 1.8 g/cm³. The elastic base layer of polyurethane may, at least in part, have a foam structure. The thickness of the base layer is preferably between 1 and 10 mm, in particular between 1 and 3 mm.

The base layer of polyurethane can be ground or roughened before being pressed with the decorative layer. This is particularly advantageous for subsequent bonds, since the adhesives can cling better into the polyurethane layer. The grinding process can also be useful to equalize unevenness of the board. According to a particular embodiment, a primer/adhesion promoter is applied upon the ground polyurethane base layer before bonding.

Unlike conventional laminations, the precursor of the panel according to the invention requires during pressing only top-side heat for connecting the top layer to the base layer. Since the base plate of polyurethane is able to conduct and store heat very well, the pressed plate is softened without destroying the binder structure of the polyurethane. This base layer which is relatively soft in the hot state also serves as a resilient cushion or press pad. The resilience of the base layer allows the production of deep structures in the surface of the pressed plate, without the need for incorporating correspondingly thick top layers. The base layer compensates for the elevations and depressions in the press plate during the pressing operation. However, because the PUR base plate has elastomeric properties, the base layer springs back after being relieved and is not substantially shaped by the structure of the press plate. The surface structure is formed in the top layer and to a certain extent in the adhesive layer.

It is suitable, when the hot plate, after pressing, is stored for cooling for a short period of time, in particular for at least ten seconds, or is even actively cooled. The pressed plate absorbs heat relatively quickly, but releases it also quickly. Storage of the cooled plates is preferably realized in stacked form only after cooling or active cooling.

As an alternative, cooling may also be implemented using cooled roll calenders, especially when pressing of the layers is realized on continuously operating press facilities.

After pressing and cooling, the thus-produced plates are cut to size and their edges are treated so as to create the panels. In addition, for optical reasons or for bonding onto a subfloor, a coating may be applied upon an underside of the plate or the panel. Also an impact sound lamination may be applied to the underside. Additionally or optionally, an anti-slip coating may be attached to the underside. Also a factory-applied adhesive layer is possible. The adhesive layer aids a fixation or bond with a subfloor.

The panels according to the invention do not require a counter-pull on the underside. Under normal conditions of use, the components of the top layer and also of the adhesive layer do not build up tensile stress that cannot be absorbed by the panel itself, in particular when the panel has a very high own weight. For that reason, there is no need for a counter-pull on the underside of the panel. In addition, the panel is intended for on-site bonding onto the subfloor.

The panel according to the invention is preferably waterproof. The panels are flexible and not rigid at all. The degree of flexibility can be adjusted via the elastomeric properties of the polyurethane material of the base layer. The material of the base layer does not involve a thermoplastic material, so that in the installed state, even when subjected to spot solar radiation or local heating, only a small or no noticeable thermally caused expansion of the panel in the finished product under normal living conditions is perceptible. Optionally, measures for improving abrasion resistance or increase of impact strength and rigidity in conjunction with the decorative layer can be used, for example in conjunction with the overlay. But also in this case, the measures for increasing the resistance of the panels according to the invention are situated above the adhesive layer, which preferably is also made of a polyurethane.

In summary, the panel according to the invention involves a polyurethane elastomeric plate in which impregnated decorative papers are connected to form a product with the base layer of polyurethane, wherein the thus-produced plate or panel is not rigid but overall flexible.

The panel according to the invention is not elastic in the sense that it can be stretched in the longitudinal and transverse directions, i.e. in the laying plane greater than 10%, or compressed greater than 5%. Resilience perpendicular to the laying plane and in particular within the top layer is undesirable. However, the invention does not require a reinforcing layer in the area of the decorative layer. The top layer can be particularly easily produced together with the base layer, so that there is no need to bond already end-pressed top layers, such as e.g. liners, to a PUR plate. The wear-resistant protective layer (overlay), the decorative layer and the adhesive layer are activated with the base layer together in one operating step during pressing and cured.

A special feature of the invention is that a base layer of PUR with higher insulation values and a relatively rigid, impregnated, paper-based decorative layer are suited to one another such that the desired bending or compression becomes possible. This is achieved by the adhesive layer provided according to the invention and by the matching strength values or elongation properties of the materials used.

When the panel is bent upwards on the decor side, the elastomerically adjusted PUR base layer expands, while the decorative side is rather compressed. Since the decor side is insensitive to thermal influences due to the aminoplastic and/or polyurethane-impregnated decorative layer, the product behaves overall dimensionally stable. When floor heating is involved, temperatures up to 30° C. are not critical. In most cases, the underside of the panel is cooler than the upper side so that the underside is not subject to greater expansion than the upper side during normal use. The adjustment and selection of materials are important features for the success of the invention.

The entire structure is to be understood as waterproof in contrast to laminate floors. The product absorbs a maximum of 5% of water, and does not tend to swell when moisture absorption is up to a maximum of 3%. The edge swells are less than 3% when stored in water after 24 h. The structure can be described as closely fitting, so that during installation no cavities are formed toward the subfloor, e.g. toward the screed. Therefore, a floor formed from these panels is very quiet when walking thereon. There is no resonance cavity. Unevenness up to 1 mm is bridged and does not show up in the top surface during use. This is a particularly advantageous aspect compared to products with a thermoplastic base layer. A structure is advantageous in which the papers are elastically impregnated in the decorative layer, but do not react in a thermoplastic way. The invention combines the advantages of a rigid laminate floor with those of floors made of waterproof, thermoplastic materials.

1.-20. (canceled)

21. A panel for covering an area of a room, said panel comprising:
a base layer made entirely or predominantly of polyurethane;
a top layer arranged above the base layer and having an elasticity which is less than an elasticity of the base layer; and
an adhesive layer via which the top layer is pressed with the base layer to form a multi-layer structure, said adhesive layer being made of a member selected from the group consisting of thermoplastic polyurethane, polyamide, and polyester, arranged as film or powder between the top layer and the base layer before the top layer is pressed with the base layer.

22. The panel of claim 21, wherein the top layer includes a decorative layer and a protective layer arranged above the decorative layer.

23. The panel of claim 22, wherein the protective layer contains an antiabrasive constituent.

24. The panel of claim 21, having an upper side, an underside, and at least four side edges, at least two of the four side edges provided with a chamfer or rabbet.

25. The panel of claim 21, wherein the base layer contains an additive on a mineral basis or on a basis of a synthetic equivalent thereof such that a density of the base layer is greater than 1.5 g/cm³.

26. The panel of claim 25, wherein the density of the base layer is greater than 1.8 g/cm³.

27. The panel of claim 21, further comprising an impact-sound-absorbing layer disposed on an underside of the base layer.

28. The panel of claim 21, further comprising an anti-slip layer or an adhesive layer arranged on an underside of the panel.

29. The panel of claim 22, wherein the decorative layer is made on a basis of cellulose and impregnated curable synthetic resin, said synthetic resin containing an aminoplastic resin, a melamine resin, a polyurethane or a mixture thereof.

30. The panel of claim 21, configured in the absence of a stabilizing underside counter-pull and bendable about the top layer towards an upper side with a bending radius of up to 25 mm, as measured from the upper side of the panel, without destruction of the panel.

31. A method for the production of a panel, comprising:
providing a base layer made entirely or predominantly of polyurethane;
arranging a top layer above the base layer;
placing an adhesive layer between the top layer and the base layer; and
pressing the top layer with the base layer in a press such that heat generated in the press and introduced at least into the top layer activates the adhesive layer to thereby form a multilayer structure.

32. The method of claim 31, further comprising adding a mineral-based additive or synthetic equivalent thereof to the base layer.

33. The method of claim 31, wherein the top layer is pressed with the base layer at a temperature in a range of 150° C. to 220° C., and further comprising adjusting the temperature at a surface of a press plate, which is brought into contact with the panel.

34. The method of claim 33, wherein the temperature is adjusted only on a single press plate, which comes into contact with the top layer.

35. The method of claim 31, wherein the top layer is pressed with the base layer at a pressing time of 8 to 30 seconds.

36. The method of claim 31, further comprising cooling down the multilayer structure for at least 10 seconds immediately after removal from the press.

37. The method of claim 33, wherein the press plate has a surface structure which is transferred into the top layer and formed only in the top layer of the panel, and, optionally, in the adhesive layer.

38. The method of claim 31, further comprising:
making the top layer of a cellulose-based decorative layer and a protective layer arranged above the decorative layer, and
adjusting a thickness of the top layer to 0.1 to 0.5 mm in dependence on a thickness and a number of plies of the cellulose-based decorative layer and the protective layer.

39. The method of claim 38, further comprising applying the protective layer in liquid form or as powder on an upper side of the decorative layer before the top layer is pressed with the base layer.

40. The method of claim 31, further comprising applying a film or powder of a meltable and curable material as the adhesive layer between the base layer and the top layer.
